(19) United States
(12) Patent Application Publication
(10) Pub. No.: US 2026/0099325 A1
(43) Pub. Date: Apr. 9, 2026

(54) EMBEDDED SYSTEM BUILD TOOL AND PLATFORM

(71) Applicant: FCA US LLC, Auburn Hills, MI (US)

(72) Inventors: Chandrasekhar Puliroju, Auburn Hills, MI (US); Sricharan Maruneni, Auburn Hills, MI (US); Snehal Sable, Auburn Hills, MI (US)

(21) Appl. No.: 18/908,973

(22) Filed: Oct. 8, 2024

(51) Int. Cl. G06F 8/71; G06F 8/41

(52) U.S. Cl. CPC G06F 8/71; G06F 8/41

(57) ABSTRACT

A software build tool system and method for generating and validating a software build for execution on a target hardware device of an embedded system. The system includes: a user interface subsystem configured for receiving build parameter data pertaining to software from a user; a build tool subsystem configured for receiving the build parameter data from the user interface subsystem and building the software to generate a software build for execution on a target hardware device of an embedded system; and a memory reporter subsystem configured for receiving the software build generated by the build tool subsystem and providing access to target hardware build validation data resulting from and/or used as a part of the software build during execution.

### FIELD

The present disclosure relates to a building software, firmware, or computer instructions (referred to collectively as “software”) and, more particularly, to generating builds for software for electronic control units (ECUs) of an automotive embedded system and/or other embedded system.

### BACKGROUND

Embedded systems, such as those found in automotive control units, medical devices, and industrial automation equipment, have traditionally relied on specialized tools and build environments to manage the process of compiling and deploying software. These systems often face challenges related to resource limitations, real-time performance requirements, and hardware-specific constraints. Historically, software development for embedded systems has involved complex toolchains that require cross-compilation for different target architectures, making the build process slower and more cumbersome compared to general-purpose software development. The tools used in these environments have generally been dependent on specific operating systems, which can limit flexibility and hinder the ability to containerize or parallelize builds. Additionally, the build execution process in conventional systems often follows a sequential pattern, which further extends build times, especially when managing large codebases across multiple controllers or devices.

To expedite the build process, some organizations have employed multi-agent solutions, splitting the workload across several build agents to parallelize the process. However, this approach introduces new challenges. Each agent typically requires its own licenses, whether for compilers or for the build infrastructure itself, increasing both the complexity and cost of maintaining the system. As a result, build environments have become increasingly expensive, with high licensing costs for proprietary tools and the need for dedicated infrastructure to support distributed builds. Additionally, integrating third-party enterprise applications into the build process can be difficult due to compatibility issues, further complicating the development workflow.

One of the major drawbacks of traditional build systems is their dependency on specific platforms, often requiring the use of a particular operating system. This dependency prevents the system from being easily adapted to modern development practices, such as containerization or parallelized builds in a cloud environment. Furthermore, these conventional systems often rely on procedural programming, which makes tool maintenance time-consuming and requires a wide range of technical expertise across different programming languages. This makes even small updates to the build process slow and inefficient, contributing to extended build times and delayed defect resolution.

Conventional technology used in embedded system builds is characterized by slow build times, high operational costs, platform dependencies, and difficulties in integrating third-party tools. These limitations have made it challenging for organizations to maintain fast and efficient build processes, especially as embedded systems grow more complex and demand faster iteration cycles.

### SUMMARY

In at least some implementations, software build tool system for generating and validating a software build for execution on a target hardware device of an embedded system, includes: a user interface subsystem configured for receiving build parameter data pertaining to software from a user; a build tool subsystem configured for receiving the build parameter data from the user interface subsystem and building the software to generate a software build for execution on a target hardware device of an embedded system; and a memory reporter subsystem configured for receiving the software build generated by the build tool subsystem and providing access to target hardware build validation data resulting from and/or used as a part of the software build during execution.

In at least some implementations, the user interface subsystem, the build tool subsystem, and the memory reporter subsystem are each configured as a microservice configured and deployed as a separate module for module-specific execution.

In at least some implementations, the user interface subsystem is configured to receive the build parameter data from a user via a command line interface and/or a graphical user interface (GUI).

In at least some implementations, the software build tool system includes a platform-independent build tool configured for generate the software build for execution on the target hardware device.

In at least some implementations, the build parameter data is specified via key-value pairs.

In at least some implementations, the memory reporter subsystem is configured to generate the target hardware build validation data and to use the build validation data to determine whether the build was successful.

In at least some implementations, the target hardware build validation data includes A2L (ASAM MCD-2 MC) and/or PCAL (Parameter Calibration) data.

In at least some implementations, the target hardware device is an electronic control unit (ECU) of an embedded vehicle system.

In at least some implementations, the build tool subsystem is configured to compile object files from source code of the software in a multi-threaded fashion whereby multiple object files of the same source code are generated.

In at least some implementations, the object files are linked after being generated in the multi-threaded fashion.

In at least some implementations, a method of generating and validating a software build for execution on a target hardware device of an embedded system, includes: receiving build parameter data from a user via a user interface subsystem; building the software module to generate a software build for execution on a target hardware device; generating target hardware build validation data based on the software build as prepared for execution by the target hardware device; and validating the software build using the target hardware build validation data.

In at least some implementations, the method is performed by a software build tool system having a plurality of subsystems configured as independent, microservices.

In at least some implementations, the plurality of subsystems includes a user interface subsystem that is configured to receive the build parameter data from a user via a command line interface and/or a graphical user interface (GUI).

In at least some implementations, the software build tool system includes a platform-independent build tool configured for generate the software build for execution on the target hardware device.

In at least some implementations, the build parameter data is specified via key-value pairs.

In at least some implementations, the target hardware build validation data includes A2L (ASAM MCD-2 MC) and/or PCAL (Parameter Calibration) data.

In at least some implementations, the target hardware device is an electronic control unit (ECU) of an embedded vehicle system.

In at least some implementations, the method is performed by a software build tool system having a build tool subsystem that is configured to compile object files from source code of the software in a multi-threaded fashion whereby multiple object files of the same source code are generated.

In at least some implementations, the object files are linked after being generated in the multi-threaded fashion.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a block diagram depicting a software build tool system for generating and validating a software build for execution on a target hardware device of an embedded system, according to one embodiment;

FIG. 2 is a block diagram and flowchart depicting the software build tool system of FIG. 1 being used for generating a software build, according to one embodiment;

FIG. 3 is a block diagram and flowchart depicting the software build tool system of FIG. 1 being used for generating target hardware build validation data, according to one embodiment;

FIG. 4 is a flowchart depicting the software build tool system of FIG. 1 being used for generating and validating a software build for execution on a target hardware device of an embedded system, according to one embodiment; and

FIG. 5 is a flowchart depicting a method for generating and validating a software build for execution on a target hardware device of an embedded system, according to one embodiment.

### DETAILED DESCRIPTION

Referring in more detail to the drawings, there is provided a build tool and platform for building software (e.g., firmware) for embedded systems, such as, for example, an automotive or vehicle embedded system comprised of electronic control units (ECUs). According to embodiments, the software build tool and platform is embodied in an automated embedded software build system and corresponding method for building software to be deployed to an embedded system for execution. The software build tool includes a user interface subsystem for receiving build parameter data pertaining to a software module from a user, a build tool subsystem for receiving the build parameter data from the user interface subsystem and building the software module to generate a software build for execution on a target ECU, and a memory reporter subsystem for receiving the software build generated by the build tool subsystem and providing access to electronic control unit (ECU) data resulting from and/or used as a part of the software build during execution.

According to embodiments, the software build tools provides a graphical user interface (GUI) to a user via the user interface subsystem, enabling the user to provide input regarding a software build to be performed, such as various build parameters or variables. In such embodiments, the user interface subsystem then sends this build parameter data to the build tool subsystem, which then builds the software according to the build parameter data. In embodiments, the build parameter data is received via a set of key-value pairs, and may be specified in a number of manners and/or formats, such as, for example, in an “ini” (or “INI”) file. The build tool subsystem compiles source code into machine code to create object files, which are then linked to generate the built software. Post-processing may be used for generating a map file (“.map” extension files), S19 (Motorola™ S-record), and/or “.out”file.

According to embodiments, the software build tool is implemented using a modular, microservices architecture in which multiple independent microservices, each with its own service offerings via an application programming interface (API) that is defined therefor. This type of arrangement is useful for scalability and flexibility. And, in some embodiments, multiple software builds may be performed in parallel on a local machine as a result of the microservices architecture. More particularly, in embodiments, multiple object files of the software are built in parallel using multi-threading techniques where, for example, multiple bash commands; these threads may then be joined and the compiled object files may be linked.

The present embodiment shown and described in the drawings is discussed in the exemplary context of an automotive system having a plurality of electronic control units (ECUs), each with different tasks. And, although the present embodiment illustrates aspects of the software build tool and its related components through the present automotive-based example and embodiment, those skilled in the art appreciate the applicability and usefulness of the software build tool technology taught herein to other electronic, embedded processing or controller systems.

ECUs in vehicles provides an example of firmware or other software being deployed to an embedded system, as such ECUs are specialized computing devices designed to manage and control various automotive functions. Indeed, modern vehicles may contain dozens of ECUs, each dedicated to specific tasks such as engine control, transmission, braking, airbag deployment, and infotainment systems. These ECUs often operate in real-time, processing data from sensors and making critical decisions that ensure the vehicle's safety, performance, and efficiency. For instance, an ECU controlling the anti-lock braking system (ABS) must respond instantaneously to sensor data to prevent wheel lockup during sudden braking. Because they are embedded within the vehicle's hardware and must communicate with other systems through dedicated communication protocols, developing software for ECUs requires precise control over timing, resource management, and hardware interaction.

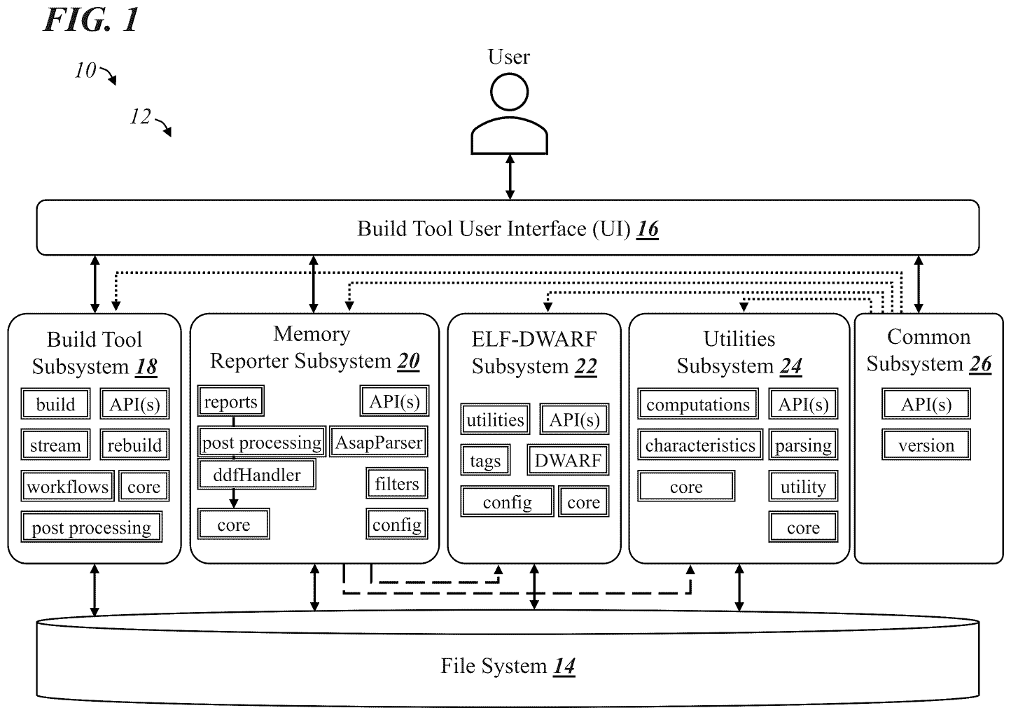

With reference to FIG. 1, there is shown a software build tool system 10 and user interacting with the system 10. The software build tool system 10 includes a software build tool 12 and a file system 14 that is accessible by the software build tool 12. The software build tool 12 includes a build tool user interface (UI) 16 that is accessible by the user, a build tool service (corresponding to a build tool subsystem) 18, a memory reporter service (corresponding to a memory reporter subsystem) 20, an ELF DWARF (Executable and Linkable Format-Debugging With Attributed Record Formats) service (corresponding to an ELF-DWARF subsystem) 22, a utilities service (corresponding to a utilities services subsystem) 24, and a common service (corresponding to a common services subsystem) 26.

In one embodiment, the software build tool 12 is implemented and configured as a microservice configured and deployed as a separate module for module-specific execution. As appreciated by those skilled in the art, a microservice is a small, independently deployable service that performs a specific function within a larger system. It follows the architecture pattern where an application is split into multiple, loosely coupled services, each responsible for a distinct functionality. Microservices can communicate with each other over network protocols (like HTTP, REST, or messaging queues) via their respective API(s) or endpoint(s).

In at least one embodiment, the software build tool 12 is implemented and configured as a platform-independent tool, meaning it is designed to work across multiple hardware architectures and operating systems without requiring modifications to the build process. This tool facilitates the automated process of compiling, linking, and packaging embedded system software, such as for ECU development, ensuring consistent builds regardless of the target platform. For example, in one embodiment, when building ECU software, this platform-independent build tool handles cross-compilation for different microcontrollers or processors, manages hardware-specific dependencies, and ensures proper integration with hardware abstraction layers (HAL) and real-time operating systems (RTOS). By being platform-independent, the tool abstracts the details of various hardware platforms, allowing developers to generate binaries, flashable images, or other platform-specific outputs without worrying about system-specific variations.

The software build tool system 10 and build tool 12 itself are implemented using computer instructions executed by at least one processor. The computer instructions may be stored on a non-transitory, computer-readable memory. Here, the at least one processor refers to one or more electronic processors. Any one or more of these processors or other processors discussed herein may be implemented as any suitable electronic hardware that is capable of processing computer instructions and may be selected based on the application in which it is to be used. Examples of types of processors that may be used include central processing units (CPUs), graphics processing units (GPUs), field-programmable gate arrays (FPGAs), application specific integrated circuits (ASICs), microprocessors, microcontrollers, etc. And, here, the memory refers to one or more non-transitory, computer-readable memory devices (or memories), and any of these memories or other memory discussed herein may be implemented as any suitable type of memory that is capable of storing data or information in a non-volatile manner and in an electronic form so that the stored data or information is consumable by the processor. The memory may be any a variety of different electronic memory types and may be selected based on the application in which it is to be used. Examples of types of memory that may be used include magnetic or optical disc drives, ROM (read-only memory), solid-state drives (SSDs) (including other solid-state storage such as solid-state hybrid drives (SSHDs)), other types of flash memory, hard disk drives (HDDs), non-volatile random access memory (NVRAM), etc.

In FIG. 1, the dotted arrows extending from the common service 26 to the services 18-24 indicate dependence or reliance of the common service 26 thereon. Also, the dashed arrows extending from the memory reporter service 20 to the ELF-DWARF service 22 and the utilities service 24 indicate dependence or reliance of the memory reporter service 20 thereon. The solid arrows extending between the build tool UI 16 and the services 18, 20, 26, as well as those extending between the file system 14 and the services 14-24, indicate data communication or access.

The software build tool 12 employs a microservices architecture in which the services 18-26 are offered each as a separate microservice, each with its own API for offering access to various endpoints (corresponding to tasks or jobs performed by the service). Each service 18-26 is implemented as a software module that is executed on a computing device and that offers at least one endpoint for receiving requests for task/service offerings by the respective service 18-26. The services 18-26 may be executed using a cloud, microservices architecture whereby cloud machine instances (e.g., Amazon Web Services (AWS) elastic computing 2 (EC2) instances) are used for hosting the respective service 18-26.

The file system 14 is used for storing various information used by the software build tool 12. The file system 14 is a data store that is used for storing data in electronic format, and may be implemented using various database technologies such as DynamoDB, SQL databases (e.g., MySQL, PostgreSQL), NoSQL databases (e.g., MongoDB, Cassandra), and/or other cloud-based storage solutions like Amazon S3 or Google Cloud Storage, for example. The file system 14 may be implemented using one or more non-transitory, computer-readable memory devices. Although the file system 14 is illustrated as a single file system, it will be appreciated that the various services 18-24 may have access to the same data stores and systems, or these services 18-24 may have separate data/file systems.

The build tool UI 16 is a human-machine interface that allows the user to input data indicating build parameters to use for a software build, and may communicate information back to the user, in some embodiments. The build tool UI 16 may be implemented as a graphical user interface (GUI), such as where the build tool UI 16 is implemented using a web application for an internet browser. For example, a web application using the Angular Javascript framework may be used. In another embodiment, a command line interface (CLI) is provided as the build tool UI 16 in addition to or in lieu of the web application interface.

The build tool UI 16 enables the user to provide build input data including build parameter data, including, for example, program type, build environment, build scope, and build type. The build input data provided by the user may include other build information as well, such as, for example, source code path and target controller or ECU identifier. The build tool UI 16 may send the build input data to a data store for storage, such as the file system 14.

The build tool service or subsystem 18 is used for building software. In the present embodiment, the build is performed by compiling source code into machine code and linking the compiled objects as needed, and in accordance with the build parameter data provided or set by the user via the build tool UI 16. The build tool subsystem 18 may generate ELF, S-records (e.g., S19 record), “.map” files, and/or “.out” files, for example. The software as compiled and linked, or otherwise appropriately built for execution on its target ECU/device, is referred to as the “software build.”

In the exemplary embodiment of FIG. 1, the build tool service 18 is shown as having one or more APIs or endpoints, build function(s), rebuild function(s), stream function(s), workflow function(s), post-processing functions, as well as other functions core to the build tool service functionality described herein.

The memory reporter service or subsystem 20 is used for receiving the software build generated by the build tool subsystem and providing access to ECU data resulting from and/or used as a part of the software build during execution. The memory reporter subsystem 20 is configured to generate an A2L file using a software build output of the software build, such as an ELF, S19, “map”, or “out” file, for example. The A2L file is a part of ASAM ((Association for Standardization of Automation and Measuring Systems) MCD-2 MC (formerly known as ASAP2) standard used in the automotive industry for ECU development and testing. This A2L file contains ECU data, such as ECU variables used in measurement and calibration, at least in the present embodiment. The memory reporter service 20 may also generate various error and/or analytical reports pertaining to the software build.

In the exemplary embodiment of FIG. 1, the memory reporter service 20 is shown as having one or more APIs or endpoints, report generation, report post-processing and DDF (Data Definition File) handling for managing ECU configuration data, AsapParser functionality for parsing and interpreting A2L files, and filtering, as well as other functions core to the memory reporter service functionality described herein.

The ELF-DWARF service or subsystem 22 is used for ELF and DWARF related functions, such as, for example, generating an “ELF” file based on the output of the build tool subsystem 18, decoding hex data, and reading intermediate file(s) generated by a build accelerator service. In the present embodiment, the ELF-DWARF subsystem 22 functions as a custom ELF generation service, which generates the “ELF” file and parses complex automotive source code in hex format. It reads intermediate files generated by the EBT build accelerator service and is responsible for generating the final ELF file. Additionally, at least in the present embodiment, the ELF-DWARF subsystem 22 supports DWARF (Debugging With Attributed Record Formats) version 2 and above, enabling access to critical debugging information. This ensures compatibility with advanced debugging techniques, allowing for efficient handling of debug symbols and enhanced code analysis capabilities throughout the development process.

In the exemplary embodiment of FIG. 1, the ELF-DWARF service 22 is shown as having one or more APIs or endpoints, DWARF or debugging functionality, tagging functions for tagging builds, as well as other functions core to the memory reporter service functionality described herein.

The utilities service (corresponding to a utilities services subsystem) 24 is used for handling various tasks related to data processing and organization. For example, this service may include a Base and COE (Component Object Engine) data parser, where “Base” refers to fundamental system information and “COE” involves more advanced engineering data structures. One of the key outputs of this service is the Phase Definition report, which compiles critical engineering details such as calibrations (fine-tuning settings), characteristics (defining system traits), variables (data holders), and system features, helping developers understand the structure and behavior of the software.

In the exemplary embodiment of FIG. 1, the utilities service 24 is shown as having one or more APIs or endpoints, parsing, utility functions, characteristics handling, various computational processing, as well as other functions core to the utility service functionality described herein.

The common service (corresponding to a common services subsystem) 26 is used for managing the software build tool 12 itself, such as for managing versioning and release information. In one embodiment, the common subsystem 26 handles tool version management, ensuring different iterations of the tool are tracked and maintained effectively, and also manages the display of application details on the UI 16 or other UI, providing users with important information about the tool's current state. And, in some embodiments, the common subsystem 26 oversees release handling, ensuring that software releases are organized and executed properly, supporting a seamless development and deployment process. In the exemplary embodiment of FIG. 1, the common service 26 is shown as having one or more APIs or endpoints and version management.

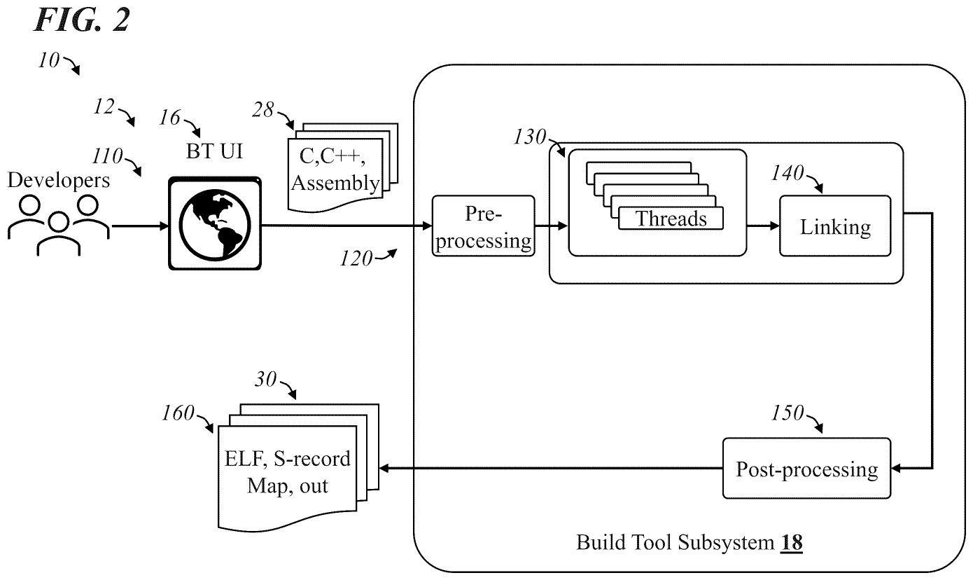

With reference now to FIG. 2, there is shown a diagrammatic module process flow diagram depicting the software build tool 12 of the software build tool system 10 being used for building software. In particular, FIG. 2 depicts a method or process 100 of building software to be deployed to an embedded system for execution. The method 100 begins with step 110, wherein the user provides build input information into the software build tool 12. The user inputted information, which may include build parameter data, is then sent to the build tool subsystem 18. The user may also specify a file location on the file system 14 of where source code 28 to be used for building the software is located, and/or the user may upload and/or otherwise provide and/or provide access to the source code. In the depicted embodiment of FIG. 2., the source code 28 is C, C++, and/or assembly code, although various other programming languages may be used. The method 100 proceeds to step 120.

At step 120, the source code 28 and the build parameter data specified by the user in step 110 is received at the build tool subsystem 18. According to embodiments, pre-processing may be performed, as shown in FIG. 2, such as for transforming build parameter data, such as from an INI file, into a suitable format for the compiling processing. Also, in some embodiments, this step includes implementing various macros or directives for preparing the source code for building, including macro expansion, where predefined macros are replaced with their corresponding values or expressions, and file inclusion, where the contents of header files (using #include directives) are inserted into the source code. And, for example, conditional compilation directives like #ifdef, #ifndef, and #endif are also processed to include or exclude portions of code based on certain conditions, allowing for flexible code management across different platforms or build configurations. The method 100 proceeds to step 130.

In step 130, the source code 28 is compiled into machine code, such as into one or more build objects. In an exemplary embodiment, during the compilation stage or compiling step, the (pre-processed) source code is transformed directly into machine code by the compiler, and this may involve analyzing the high-level source language, such as C or C++, and converting it into a series of machine instructions that the CPU can execute. Optimizations may be applied, such as minimizing redundant operations or reordering instructions to improve performance. The output of this compiler is machine code specific to the target ECU or other hardware, consisting of binary instructions. This machine code, often in the form of object files, can then be linked with other object files to produce a complete executable or library. The method 100 proceeds to step 140.

In step 140, the machine code, such as the object files thereof, are linked to form an executable software build. In one embodiment, this linking step is often considered a final phase of the compilation process, where individual object files, produced from the compiled source code, are combined to create a single executable or library. Generally, during linkage, the linker resolves references between different modules or object files, such as function calls or variables defined in separate files, and ensures that all external references are matched with their correct definitions, linking them together into a cohesive whole. The linker, which is a submodule of the build tool subsystem 18, also integrates standard libraries or external dependencies that the program relies on, incorporating their machine code into the final binary. In addition to resolving references, the linker may perform optimizations, such as removing unused code or merging duplicate sections. Once the linking is complete, the result is a fully formed executable, ready to be run on the target ECU or hardware, at least in the present embodiment. The method 100 proceeds to step 150.

In step 150, post-processing is performed for the executable software build. After linking, as a part of the post-processing step, further refining and preparing of the final executable or library for distribution or deployment may be performed, such as, for example, symbol stripping (where unnecessary debugging symbols or metadata are removed to reduce the file size and protect proprietary information), relocating or adjusting addresses for dynamic linking if/when shared libraries are used, ensuring that the executable can correctly reference external libraries at runtime, final optimizations (e.g., compressing certain sections of the binary or aligning memory segments for improved performance), and/or signing the binary for security purposes is done to ensure its integrity and authenticity. The method 100 then proceeds to step 160.

In step 160, generating one or more formatted output files for the executable software build. After the post-processing step 150 following linking in step 140, files like ELF, S-record, Map, and out files 30 may be useful for execution and/or deployment of the executable software build. For example, generating such files typically involves specific flags or commands passed to the linker or additional post-link tools. The ELF file, commonly used on Unix-based systems, is usually the default output of the linker when generating executables or shared libraries, and is produced by the linker when invoking a command like ‘gcc’ or ‘ld’, and the output will be an ELF file by default if the platform supports it. For generating an S-record file, used in embedded systems, an additional tool like ‘objcopy’ is used, and an ELF or binary file may be converted into an S-record format by running a command like ‘objcopy-O srec input.elf output.srec’, which transforms the binary data into the hex-encoded S-record format suitable for loading into memory or flash. The Map file, which provides detailed memory layout and symbol information, is typically generated by passing a flag like ‘-WI, Map, output.map’ to the linker, instructing it to produce a detailed map of how symbols and sections are placed in memory. The ‘out’ file is often a platform-specific or generic output that can be produced with a flag, and its purpose may vary depending on the environment. These outputs 30 help facilitate debugging, deployment on different hardware platforms, and analysis of memory usage and symbol resolution within the final executable. The method 100 ends.

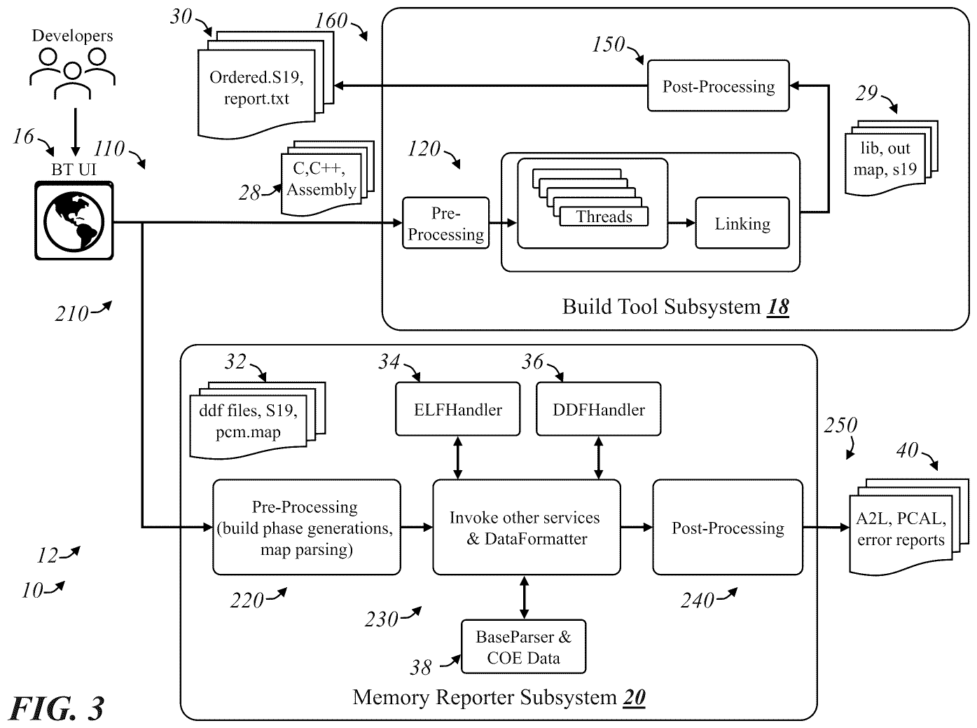

With reference to FIG. 3, there is shown a diagrammatic module process flow diagram depicting the software build tool 12 of the software build tool system 10 being used for building software. In particular, FIG. 3 depicts the method or process 100 of building software to be deployed to an embedded system for execution (and discussed above in connection with FIG. 2), and further includes a method or process 200 of providing an embedded software build tool to generate a software build and evaluate the software build.

The method 200 begins with step 210, wherein a user embedded hardware access request is received at the software build tool 12. The user embedded hardware access request is a request to access information on the ECU or other target hardware device on which the software build (the software built during the process 100) is executed. The user embedded hardware access request is shown as being received at the memory reporter subsystem 20 via the build tool UI 16. The user embedded hardware access request may provide the executable source code and/or otherwise indicate where the source code is, such as the formatted executable source code 30 and/or the executable source code 29 (before post-processing of step 150). Moreover, other suitable inputs, such as a map file for the ECU and/or a device description file (DDF). The method 200 proceeds to step 220.

In step 220, pre-processing is performed in order to properly initialize and/or placing the information in place for accessing the target ECU or hardware device. In at least one embodiment, during this pre-processing step, various tasks may be performed to ensure accurate communication between the ECU and external calibration or measurement tools, such as, for example, parsing the executable built software as well as the associated map and DDF files to critical information about the memory layout and communication protocols. In one embodiment, the map files, generated during the build phase, contain memory addresses for parameters and variables within the ECU, which are then cross-referenced with the variable definitions in the A2L file. According to embodiments, this pre-processing step helps to ensure that the A2L memory reporter correctly correlates memory addresses with their respective variables, enabling precise calibration and measurement access. Additionally, the DDF file may be used to define how the tools interact with the ECU, detailing protocols, communication setups, and configuration options. The pre-processing phase may also include verification to detect any discrepancies between the map file and the A2L file, which helps prevent errors during ECU calibration and testing. The method 200 proceeds to step 230.

In step 230, embedded hardware data is parsed, extracted, and/or otherwise accessed from the target ECU or embedded device executing the software build. In embodiments, files such as the ELF file and the DDF are processed using specialized handlers responsible for parsing the intricate details of the compiled software and the communication protocols that will be used by calibration and measurement tools. Generally, in embodiments, the aim is to ensure that the memory mappings and protocol information are accurately translated and structured into a usable format that can be easily accessed by other systems or tools during calibration, diagnostics, or testing.

According to the depicted embodiment, an ELFHandler 34 is responsible for managing the ELF file, which contains compiled code and data used by the ECU. During this phase, the ELFHandler 34 may extract important or useful information about memory layout, variable definitions, and function addresses from the ELF file. This data is useful as it provides the precise memory locations where various parameters and calibration data reside and, by analyzing the ELF file, the handler operates to ensure that any subsequent operations involving the ECU's memory are accurate, allowing tools to correctly access and modify the ECU's internal variables during calibration or diagnostics.

Also, in the depicted embodiment, a DDFHandler 36 is used for, on the other hand, processing the DDF file, which describes how the ECU communicates with external devices. The DDFHandler 36 may parse the DDF to extract protocol information, communication parameters, and device-specific settings, and this may include details such as the communication protocol being used (e.g., CAN (Controller Area Network), XCP (Universal Measurement and Calibration Protocol)), message formats, and timing constraints. The DDFHandler 36 ensures that the system is aware of how to communicate with the ECU, facilitating seamless interaction between the calibration tools and the ECU for real-time data retrieval or parameter adjustments.

In the present embodiment, once the ELFHandler 34 and DDFHandler 36 have processed their respective files, the information is passed along to a central service, which may utilize a BaseParser (or other parser) and COE data (as indicated at 38) in conjunction with a DataFormatter to standardize and organize the extracted information. In one embodiment, the BaseParser handles data parsing tasks, such as interpreting ECU data structures, memory layouts, and/or base configuration settings. The COE data (Calibration and Operational Elements) represents the specific calibration settings and operational configurations that define how the ECU performs in practice. This data may be used to ensure that or evaluate whether the ECU operates according to its intended behavior, incorporating both default and adjustable calibration values. When processed together with the parsed memory and protocol information, the COE data helps align the actual software running on the ECU with its calibrated operational state.

In one embodiment, a DataFormatter then standardizes this combined data set, ensuring that all information—whether from the ELFHandler, DDFHandler, BaseParser, or COE data—follows a structured format compatible with downstream processes. This allows calibration and diagnostic tools to interact with the ECU reliably, ensuring that memory addresses are properly mapped, calibration parameters are correct, and communication protocols are configured for accurate testing, calibration, or diagnostic tasks. The method 200 proceeds to step 240.

In step 240, post-processing is performed in order to perform any appropriate processing, such as refining and/or further organizing the data parsed and formatted during earlier stages. For example, this post-processing may be used for ensuring and/or evaluating whether the data is structured properly for the final stages of ECU calibration, diagnostics, or testing. In one embodiment, this step involves verifying that memory addresses align with calibration parameters, such as for purposes of ensuring that data extracted from ELF and DDF files is properly formatted and corresponds to the ECU's operational needs. Any inconsistencies or discrepancies, whether related to memory mappings, protocols, or parameter definitions, may be detected and flagged for correction and/or inspection. Post-processing may also include the consolidation of data formats to match predefined ECU communication protocols, and the generation of error reports to address potential issues. The method 200 proceeds to step 250.

In step 250, target hardware build validation data (also referred to as build validation data) is generated, such as, for example, A2L file(s), PCAL (Parameter Calibration) file(s), and/or error reports, as indicated at 40. In one embodiment, an A2L file is generated based on the memory and parameter information validated during post-processing, and the A2L file includes detailed descriptions of the ECU's calibration parameters, measurement points, scaling factors, memory locations, and/or other data useful for calibration tools to interface with the ECU, for example. This file serves as the bridge between the ECU and external tools, allowing engineers to interact with the ECU's internal systems for real-time tuning and diagnostics.

Also, according to embodiments, PCAL data is generated, where the PCAL data provides a structured set of calibration points based on the processed memory layout and parameter definitions. The PCAL data may be used for performance tuning, as it provides information used for modifying specific ECU parameters like fuel mapping or boost pressure, for example. The generation of PCAL data involves aligning the actual memory locations with their corresponding calibration parameters, ensuring that adjustments made in the field will be accurately reflected in the ECU's performance.

In some embodiments, in addition to the A2L and/or PCAL file(S), a detailed error report may be generated. The error report may include a variety of information about any errors during documenting any unresolved issues that may require manual intervention. Any of the generated files 40 may be stored in memory, such as in the file system 14. The method 200 ends.

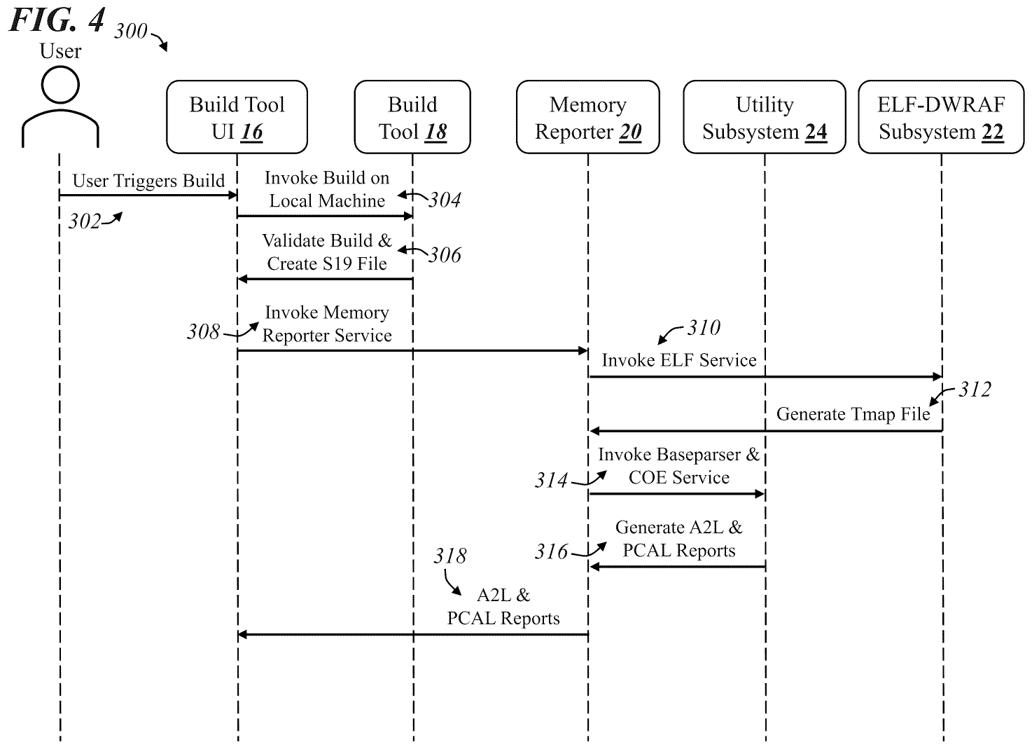

With reference to FIG. 4, there is shown a method 300 of generating and validating a software build for execution on a target hardware device of an embedded system. According to one embodiment, the method 300 combines aspects of the method 100 and 200 discussed above (FIGS. 2-3). The method 300 is used for generating a software build for software to be deployed to an embedded system for execution and build validation data for the software build. The method 300 is performed by the software build tool system 10 in the present embodiment.

The method 300 begins with step 302, wherein the user triggers a build of software, particularly through use of the build tool UI 16. For example, the user may use an CLI of the build tool UI 16, according to one embodiment. In another embodiment, the user may use a GUI hosted by a web application of the build tool UI 16. User input data may include various information, such as, for example, build parameter data. The method 300 proceeds to step 304.

In step 304, the build is invoked on a local machine, which refers to the computing machine that is performing the build and, in the present embodiment, that is implemented using the build tool subsystem 18. The build tool subsystem 18 is used to initiate and perform the build. The method 300 proceeds to step 306.

In step 306, the build is validated and any appropriate output files, such as S19 file(s), are generated. This step is performed by the build tool subsystem 18 at the local machine as well, at least in the present embodiment. The method 300 proceeds to step 308.

In step 308, the memory reporter service is invoked, particularly for initiating generation of build validation data, such as A2L and/or PCAL file(s). The build tool UI 16 automatically invokes the memory reporter service so as to cause this generation process to be performed, which generally corresponds to the process 200 above. The method 300 proceeds to step 310.

In step 310, the memory reporter subsystem 20 invokes the ELF service and causes a map file, particularly a task map (“Tmap”) file, to be generated at step 312 by the ELF-DWARF subsystem 22. A Tmap file (often referred to in automotive and embedded systems contexts) is a specialized file associated with ECU (Electronic Control Unit) software, typically found in environments where the ELF (Executable and Linkable Format) is used. The method 300 proceeds to step 314.

In step 314, a BaseParser (or other parser) and COE data (see data 38) may be used in conjunction with a DataFormatter to standardize and organize the extracted information, as discussed above in step 230 of the method 200 (FIG. 3). The method 300 proceeds to step 316.

In step 316, build validation data, such as A2L and/or PCAL data, is generated. For example, as discussed above, the memory reporter subsystem 20 generates A2L and PCAL file(s), which may then be provided to the build tool UI 16, as indicated at step 318. The method 300 then ends.

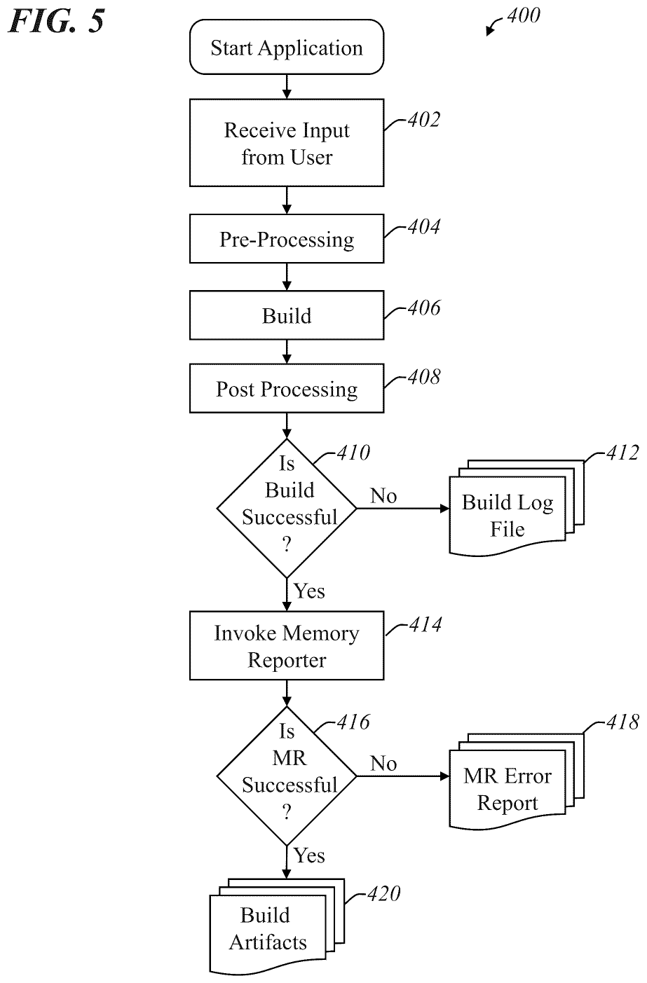

With reference to FIG. 5, there is shown an embodiment of a method 400 of generating and validating a software build for execution on a target hardware device of an embedded system. According to one embodiment, the method 400 combines aspects of the method 100 and 200 discussed above (FIGS. 2-3). The method 400 is used for generating a software build for software to be deployed to an embedded system for execution and build validation data for the software build.

The method 400 begins with step 402, wherein input is received from the user, such as build parameter data and/or other information concerning the build. The build parameter data is received from the user at the build tool UI 16 and then is provided to the build tool subsystem 18. The method 400 proceeds to step 404.

In step 404, build pre-processing is performed by the build tool subsystem 18, such as the pre-processing discussed above in step 120 of the method 100. That discussion of the method 100 is hereby incorporated and attributed to the step 404. The method 400 continues to step 406.

In step 406, the source code 24 is built into a software build comprised of machine code. This step is performed by the build tool subsystem 18, at least in one embodiment, and is discussed above in the method 100 at step 130; that discussion of the step 130 is hereby incorporated and attributed to the step 406. The method 400 continues to step 408.

In step 408, build post-processing is performed by the build tool subsystem 18, such as the post-processing discussed above in step 140 of the method 100. This step is performed by the build tool subsystem 18, at least in one embodiment, and is discussed above in the method 100 at step 140; that discussion of the step 140 is hereby incorporated and attributed to the step 408. The method 400 continues to step 410.

In step 410, a determination is made as to whether the software build generated by the build tool subsystem 18 was successful. For example, determining the build completed successfully may include determining whether the compilation and linking process completed without any errors, indicating that the source code has been successfully transformed into machine-readable object code. The ELF file, which contains the executable code, data sections, and symbolic information, must be generated correctly, signifying that the code and data are properly linked. The subsequent conversion into an S-record (SREC), often used for flashing the software onto the ECU, should also be free of errors. Once these files are generated, additional checks like code size verification, memory mapping consistency, and validation of calibration data (if applicable) may be performed. This step 410 may also include running automated tests or static analysis tools to ensure the build meets functional and quality requirements before being deemed fully successful. When it is determined that the build is not successful, the method 400 continues to step 412; and, when it is determined that the build is successful, the method 400 continues to step 414.

In step 412, a build log file is stored in the file system 14 and/or may be provided to the build tool UI 16 and, using the UI 16, to the user so that the user (who may be a developer) can analyze the logs.

In step 414, the memory reporter subsystem 20 is invoked in order to generate build validation data for the software build for validating the software build. The memory reporter subsystem 20, at least in one embodiment, generates the A2L file(s) and/or PCAL file(s), for example, as is discussed above in the method 200 at step 250 and the method 300 at step 316; those discussions of the step 250 of the method 200 and the step 316 of the method 300 are hereby incorporated and attributed to the step 414. The method 400 continues to step 416.

In step 416, it is determined whether the memory reporter (MR) is successful, which means whether the build validation data indicates a successful build for the target ECU or hardware of the embedded system. In one embodiment, it is determined whether the Memory Reporter (MR) is successful by evaluating the build validation data, specifically the A2L and/or PCAL file(s), to ensure the build is appropriate for the target ECU or embedded system hardware. The A2L file contains information about the memory layout, calibration parameters, and measurement variables, while the PCAL file is used for calibration data validation. If these files correctly represent the memory allocation and calibration structure for the specific hardware, and no discrepancies or errors are found, the build is considered successfully validated. If the build validation data indicates the MR is not successful, the method 400 continues to step 418; and, if the build validation data indicates the MR is successful, the method 400 continues to step 420.

In step 418, an MR error report is generated and stored. This MR error report may also be provided to the build tool UI 16 and to the user via the UI 16, for example. In embodiments, the MR error report is used for indicating discrepancies or issues found in the build validation data, such as details about mismatches in memory allocation, calibration variables, or any inconsistencies in the A2L and/or PCAL files compared to the expected configuration for the target ECU or hardware. The error report may be reviewed by developers or engineers (the user), who use the provided information to identify and correct the underlying problems or issues.

In step 420, the build process proceeds to output the final build artifacts. In one embodiment, the build artifacts include the ELF or S-record files, along with the validated A2L and/or PCAL files. These files represent the executable code, memory layout, and calibration data for the target ECU or hardware. The successful build artifacts may then be packaged and ready for flashing onto the ECU or other target hardware device. The method 400 ends.

What is claimed is:

1. A software build tool system for generating and validating a software build for execution on a target hardware device of an embedded system, comprising:
a user interface subsystem configured for receiving build parameter data pertaining to software from a user;
a build tool subsystem configured for receiving the build parameter data from the user interface subsystem and building the software to generate a software build for execution on a target hardware device of an embedded system; and
a memory reporter subsystem configured for receiving the software build generated by the build tool subsystem and providing access to target hardware build validation data resulting from and/or used as a part of the software build during execution.

2. The system of claim 1, wherein the user interface subsystem, the build tool subsystem, and the memory reporter subsystem are each configured as a microservice configured and deployed as a separate module for module-specific execution.

3. The system of claim 1, wherein the user interface subsystem is configured to receive the build parameter data from a user via a command line interface and/or a graphical user interface (GUI).

4. The system of claim 1, wherein the software build tool system includes a platform-independent build tool configured for generate the software build for execution on the target hardware device.

5. The system of claim 4, wherein the build parameter data is specified via key-value pairs.

6. The system of claim 1, wherein the memory reporter subsystem is configured to generate the target hardware build validation data and to use the build validation data to determine whether the build was successful.

7. The system of claim 6, wherein the target hardware build validation data includes A2L (ASAM MCD-2 MC) and/or PCAL (Parameter Calibration) data.

8. The system of claim 1, wherein the target hardware device is an electronic control unit (ECU) of an embedded vehicle system.

9. The system of claim 1, wherein the build tool subsystem is configured to compile object files from source code of the software in a multi-threaded fashion whereby multiple object files of the same source code are generated.

10. The system of claim 9, wherein the object files are linked after being generated in the multi-threaded fashion.

11. A method of generating and validating a software build for execution on a target hardware device of an embedded system, comprising:
receiving build parameter data from a user via a user interface subsystem;
building the software module to generate a software build for execution on a target hardware device of an embedded system;
generating target hardware build validation data based on the software build as prepared for execution by the target hardware device; and
validating the software build using the target hardware build validation data.

12. The method of claim 11, wherein the method is performed by a software build tool system having a plurality of subsystems configured as independent, microservices.

13. The method of claim 12, wherein the plurality of subsystems includes a user interface subsystem that is configured to receive the build parameter data from a user via a command line interface and/or a graphical user interface (GUI).

14. The method of claim 12, wherein the software build tool system includes a platform-independent build tool configured for generate the software build for execution on the target hardware device.

15. The method of claim 14, wherein the build parameter data is specified via key-value pairs.

16. The method of claim 11, wherein the target hardware build validation data includes A2L (ASAM MCD-2 MC) and/or PCAL (Parameter Calibration) data.

17. The method of claim 11, wherein the target hardware device is an electronic control unit (ECU) of an embedded vehicle system.

18. The method of claim 11, wherein the method is performed by a software build tool system having a build tool subsystem that is configured to compile object files from source code of the software in a multi-threaded fashion whereby multiple object files of the same source code are generated.

19. The method of claim 18, wherein the object files are linked after being generated in the multi-threaded fashion.
